(19) United States
(12) Patent Application Publication
(10) Pub. No.: US 2008/0162712 A1
(43) Pub. Date: Jul. 3, 2008

(54) METHOD AND APPARATUS TO FACILITATE SHARING STREAMING CONTENT VIA AN IDENTITY PROVIDER

(75) Inventors: Zhi Fu, Lake Zurich, IL (US); Gregory W. Cox, Schaumburg, IL (US); John C. Strassner, North Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/616,628

(22) Filed: Dec. 27, 2006

(51) Int. Cl. G06F 15/16

(52) U.S. Cl. 709/231

(57) ABSTRACT

An identity provider (200) communicates (101) with a first logged-in user who seeks to receive particular streaming content at a first corresponding first user platform and who has also identified at least one other user with whom this user wishes to share the receiving of this content. The identity provider invites (102) the other user to share in the receiving of this content. Upon receiving (103) an acceptance of the invitation from the other user, the identity provider can treat this other user as a logged-in participating second user (i.e., a user who is now both logged-in (even if this user was not previously logged-in) and who wishes to accept the invitation and participate in viewing the streaming content selected by the first user) and automatically direct (104) these users to a content provide to facilitate the substantially simultaneous receipt of the streaming content at all of the corresponding user platforms.

### TECHNICAL FIELD

This invention relates generally to streaming content and single sign on mechanisms based on identity management.

### BACKGROUND

Streaming content of various kinds is known in the art. This includes, but is not limited to, audio-only content, visual-only content, and audio-visual content as well as interactive content of various kinds. Streaming content typically comprises data (such as multimedia data) transferred in a stream of packets that are interpreted and rendered, substantially in real time, by a software application more or less as the packets arrive (with buffering often being used to smooth out short temporal reception interruptions). Consequently, streaming content approaches are useful when providing content such as music content, cinematic content, and so forth.

Present approaches will permit a mobile two-way communications device (such as a properly configured cellular telephone or the like) to select streaming content of choice and to receive and render that streaming content at the device for consumption by a user of that device. As such devices tend to have relatively small user interfaces, the consuming audience for such a stream must usually, as a practical matter, remain fairly small. There are times, however, when a group of users (such as a group of friends or other members of a shared affinity group) may wish to consume a given stream in a substantially simultaneous manner. To meet such a need, such a stream must be provided to each of a plurality of corresponding reception/playback platforms (such as a plurality of properly configured cellular telephones).

Scheduling, coordinating, and synchronizing such playback poses a number of challenges. Some prior art approaches (such as Micorosoft Windows Netmeeting or Media Player) employ a client-server model to facilitate such service. Such an approach, unfortunately, can be relatively non-intuitive, offer only limited capabilities, and require out-of-band invitations and pre-established times to access, play, and/or view the content. These and other limitations make this approach not conducive to spontaneous viewing. In fact, the use of prior art approaches similar to Netmeeting or Media Play will be sufficiently challenging to would-be participants to frustrate them to a point where they often abandon the attempt. This, in turn, can lead to frustrated users and frustrated system operators as well. Furthermore, the above approaches often provide little in the way of security as concerns the users themselves.

### BRIEF DESCRIPTION OF THE DRAWINGS

The above needs are at least partially met through provision of the method and apparatus to facilitate sharing streaming content via an identity provider described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a flow diagram as configured in accordance with various embodiments of the invention;

FIG. 5 comprises a call flow diagram as configured in accordance with various embodiments of the invention;

FIG. 6 comprises a call flow diagram as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an identity provider communicates with a first logged-in user who seeks to receive particular streaming content at a first corresponding first user platform. The first logged-in user has also identified at least one other user with whom the first logged-in user wishes to share the receiving of the particular streaming content. As but one illustration in this regard, this can comprise the user selecting a particular movie from amongst a plurality of available of movies and then identifying a friend with whom to watch this movie.

As used herein, an identity will be understood to comprise a set of one or more attributes that uniquely distinguish an entity, such as an individual, device, application or process. An identity provider is an organization that: (1) creates and manages identity information, (2) maintains authentication mechanisms to identify an entity, (3) maintains attributes that identify an entity, and (4) is trusted by its users.

The identity provider uses the identity information of the first user and the at least one other user to invite the at least one other user to share in the receiving of this particular streaming content. The particular form and nature of this invitation can assume different forms as appropriate to suit the needs and/or opportunities of a given application setting. For example, the specific protocol observed can vary with respect to whether this other user is, or is not, presently logged-in with the identity provider.

Upon receiving an acceptance of the invitation from the other user(s) when the other user(s) is logged-in from a corresponding second user platform, the identity provider can treat this other user(s) as a logged-in participating second user (i.e., a user who is now both logged-in (even if this user was not previously logged-in) and who wishes to accept the invitation and participate in viewing the streaming content selected by the first user). The identity provider can then automatically direct these users to a content provider to facilitate the substantially simultaneous receipt of the particular streaming content at all of the corresponding user platforms.

Those skilled in the art will appreciate that these teachings permit a user to be identified by a set of one or more attributes that enable (but do not necessarily demand) anonymous access to resources and services. Once identified, the system can use any set of authentication, authorization, and accounting (AAA) mechanisms of choice and/or availability to verify that the user, represented by a verified identity, has permission to access resources and/or services requested by the user (for example, streaming content). This is accomplished using an identity provider that is responsible, at least in large measure, for establishing the identity of the first logged-in user as well as any other users with whom the first logged-in user wishes to share the receiving of the streaming content.

Those skilled in the art will further appreciate and understand that the identity provider can establish the identity of all such users by either communicating directly with the user and/or with the content provider in question. This, in turn, permits these teachings to be readily employed in support of a wide variety of service paradigms and application settings.

So configured, a given user can readily select the streaming content in a relatively intuitive manner and can also select one or more other users with whom to possibly consume this content at the same time (albeit using different rendering platforms). Similarly, other users are directed in a clear and intuitive manner with respect to sharing in the consumption of that content if they are so inclined. Those skilled in the art will understand and appreciate that these teachings are readily deployed, do not represent a burdensome cost, and are highly scalable and leveragable to fit and accommodate a wide variety of application settings.

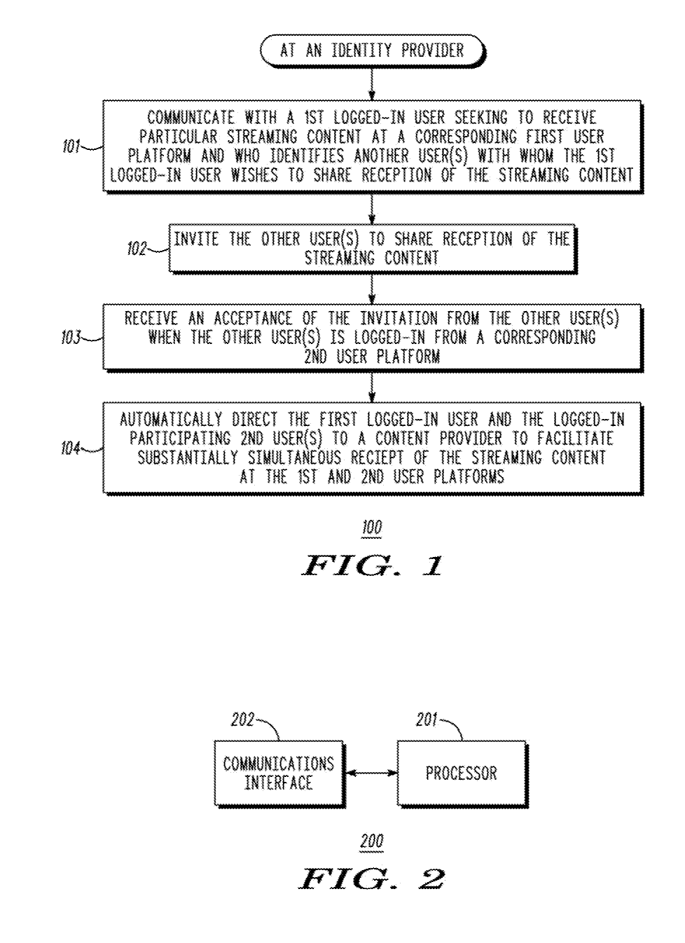

These and other benefits may become clearer upon making a thorough review and study of the following detailed description. Referring now to the drawings, and in particular to FIG. 1, a process 100 suitable for use by, for example, an identity provider will be described. As used herein, an identity provider will be further understood to refer to a platform and service that provides identity services for (typically) a plurality of both users as well as content providers with whom the identity provider has established service and trust agreements and arrangements. A given user can then, for example, log in to be authenticated by the identity provider and then readily gain transparent access to the various content providers mentioned above.

This can include use, for example, of such known functionality as Single Sign On (SSO) such that when such a user requests access to such a content provider, the identity provider will send an assertion to the content provider to assure the latter regarding the authenticated status of the user. Accordingly, the content provider can grant access to the requested service/content without requiring re-authentication from the user. Those skilled in the art will appreciate that multiple content providers can be served by a same identity provider, thereby readily enabling this approach to scale as desired.

By one approach, such a user can become logged-in with such an identity provider in a relatively direct manner. That is, the user can directly access the identity provider (for example, by accessing a web site as corresponds to that identity provider) and cooperate with a log-in process to achieve such status. By another approach, such a status can be attained in somewhat less direct ways. As but one illustration in this regard, the user might be directed to such an identity provider by the content provider from whom the user is seeking to receive the content in question. This direction (or, if desired, re-direction as is known in the art) can occur in as transparent a manner as may be desired and could be triggered by any of a variety of circumstances including, but not limited to, the user selecting a particular item of content to receive the user clicking on an identity provider link at the content provider site. Through identity federation, the user only logs in once regardless of whether the user first visits the identity provider's web portal or the content provider's web portal.

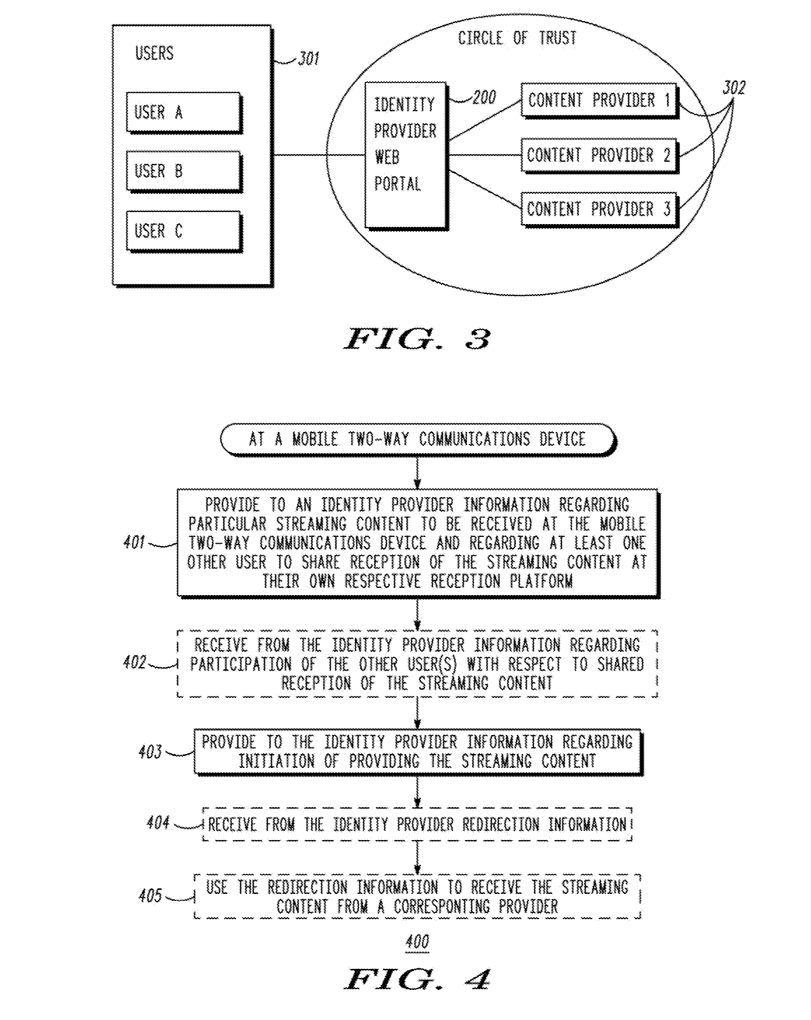

Referring momentarily to FIG. 2, such an identity provider 200 can be comprised, for example, of a processor 201 that operably couples to a communications interface 202. The communications interface 202 facilitates the aforementioned communications with users and content providers along with other communications contemplated herein. The processor 201 can comprise a dedicated-purpose platform or a partially or wholly programmable platform as are known in the art. So configured, the processor 201 can be readily configured and arranged (via, for example, corresponding programming as will be well understood by those skilled in the art) to carry out selected teachings as are presented herein. (Identity providers in general comprise an understood area of endeavor. As the present teachings are not overly sensitive to the selection of any particular technology, architecture, and platform in this regard, for the sake of brevity further elaboration regarding such identity providers is not provided herein except where appropriate to the description below.)

Referring again to FIG. 1, such an identity provider can communicate 101 with a first logged-in user who seeks to receive particular streaming content at a corresponding first user platform. This can comprise, if desired, providing the first logged-in user with a plurality of candidate streaming content options (using, for example, a display and a browser-based interface) and then receiving from this user a selection of a particular one (or ones) of the plurality of candidate streaming content options that the first logged-in user desires to receive. The identity provider can then provide the identity of the first logged-in user to the content provider or set of content providers, so that the content provider (or providers) can provide the selected streaming content of the first logged-in user at the above-mentioned corresponding first user platform. The particular nature of the streaming content can of course vary with the needs and/or opportunities presented by a given application setting. Examples include, but are not limited to, audio-only streaming content, video-only streaming content, audio-visual streaming content, and/or interactive streaming content, all of which are presently known and well-understood in the art.

This step can further comprise communicating 101 with the first logged-in user who also identifies at least one other user with whom the first logged-in user wishes to share the receiving of the particular streaming content. This can comprise receiving specific identifying information from the first logged-in user regarding this other user (such as a platform identifier, a registered username or alias for the other user, or the like). By another approach, a selection of available candidate users can be presented for selection by the first logged-in user. The latter approach can be based, for example, upon a profile for the first logged-in user that includes such information as may have been previously entered by the first logged-in user (either directly or on behalf thereof by, for example, an administrator), as may have been learned by the identity provider through previous transactions with the first logged-in user, and so forth.

Using this information the identity provider then invites 102 the at least one other user to share in the reception of the streaming content that has been selected by the first logged-in user. This can comprise, for example, transmitting a message to the at least one other user. The specific nature of this message can of course vary with any number of factors including, for example, whether the other user is presently logged-in or not. When logged-in, for example, the invitation can likely be provided to the user by use of a corresponding communication protocol by which these two elements communicate. When not logged-in, other mechanisms can be used that do not depend upon a logged-in status such as, but not limited to, a short message service (SMS) message, an email message, an instant messaging (IM) message, a voice message, a page, or the like. By one approach, if desired, the identity provider may access a presence server to receive information regarding a present location as corresponds to the other user in order to better direct and/or select a particular messaging technique. This has the advantage of alerting the first logged-in user as to which other users can, at this moment, receive the shared content.

In this example, the identity provider receives 103 a response comprising an acceptance of the invitation from the at least one other user. By one approach, the other user provides this response following a log-in procedure that establishes a given corresponding second user platform as a logged-in participating second user. As noted above, the other user may already have been logged-in at the time of receiving the invitation. In such a case the other user can simply respond in kind. When the other user was not already logged-in at the time of receiving the invitation, the other user can log-in (for example, at a web portal for the identity provider) to then complete the invitation acceptance process. By one approach, the invitation can include instructions, a link, or other mechanism to assist the recipient with respect to becoming logged-in in order to accept the invitation.

If desired, a time out mechanism or the like can be employed to determine whether to automatically resend such an invitation and/or to automatically conclude that the other user is either unavailable or uninterested in sharing the reception of the streaming content. These teachings will also readily accommodate, if desired, receiving and appropriately processing a response from the other user indicating that the invitation is declined. This might comprise, by one approach, providing a corresponding indication to the originating first logged-in user.

Upon receiving an acceptance to such an invitation, this process 100 then provides for automatically directing 104 the first logged-in user and the logged-in participating second user (or users) to the selected one or more content providers to facilitate substantially simultaneous receipt of the particular streaming content at the first and second user platform (or platforms). (For example, the same content may be available from multiple content providers, and the two users, being in different locations and/or being subscribed to different content providers, may choose and/or have access to different content providers. In addition, or in the alternative, a single content provider often makes use of mirror sites which comprise other physical content locations that such users can access.) This can comprise, where appropriate, having the identity provider provide some required assertions for user authentication to the content provider on behalf of the first logged-in user and the logged-in participating second user(s). This could also comprise, if desired and as an illustrative example, automatically redirecting browsers of the first logged-in user and the logged-in participating second users to the requested content site or sites to facilitate this result.

Those skilled in the art will recognize and understand that these teachings are readily applied in a variety of differing application settings. As but one illustration in this regard, the above can comprise providing the first logged-in user with a plurality of candidate streaming content options and then receiving from the first logged-in user a selection of a particular one of the plurality of candidate streaming content options to thereby identify the particular streaming content to be received at the corresponding first user platform, wherein the plurality of candidate streaming content options are available to be sourced by at least one content server and possibly more. A selection of the particular one of the plurality of content streaming options can then be transmitted to the at least one other user and the particular streaming content option then matched to a set of streaming content options that are available to the at least one other user. The identity provider can then coordinate with the at least one other user a use of selected content provider options.

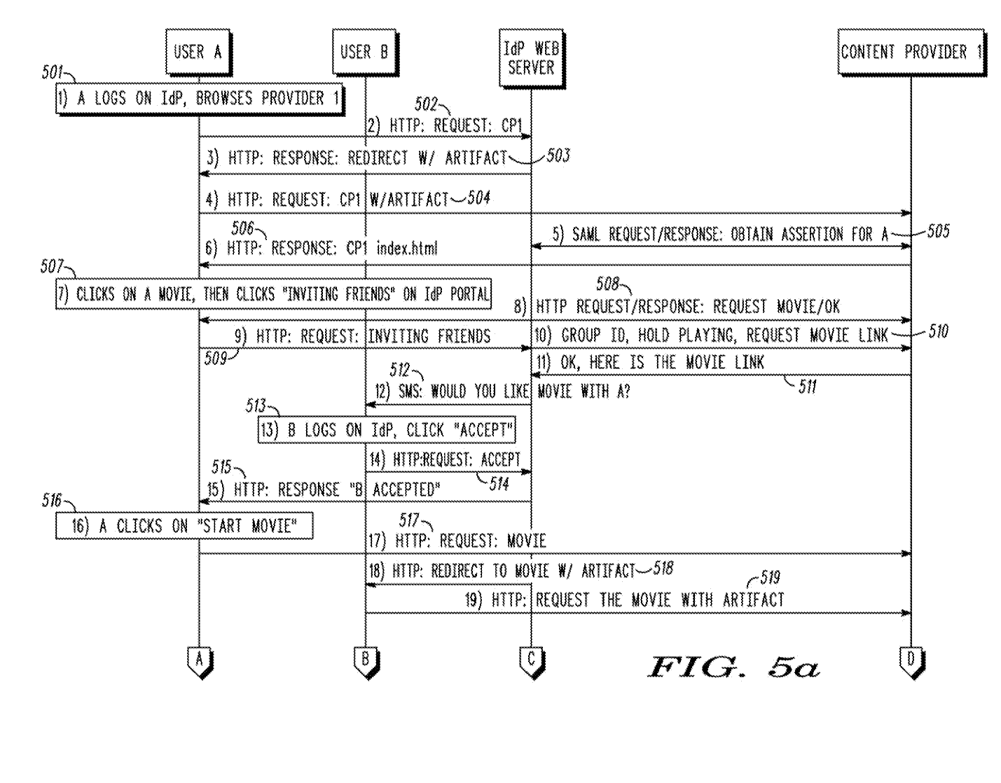

FIG. 3 presents a simple illustrative example in this regard. Here, a plurality of users 301 are serviced by a given identity provider web portal 200 that in turn comprises a part of a circle of trust that includes a plurality of content providers 302. So configured, User A can contact the identity provider web portal 200 to explore available streaming content. Upon selecting streaming content from, say, Content Provider 1 and indicating a desire to share consumption of the streaming content with User B and User C, the identity provider web portal 200 transmits a corresponding invitation to Users B and C. Upon receiving, in this example, an acceptance from both User B and User C when both have logged-in with the identity provider web portal 200, the latter facilitates the delivery of the selected streaming content from Content Provider 1 to each of User A, User B, and User C at their respective user platforms. This can comprise, as will be noted below in more detail, the provision of certain required assertions to Content Provider 1 on behalf of these various users to facilitate their relatively transparent reception of the content in question.

It will be understood by those skilled in the art that communications between two or more identity providers in support of such functionality can comprise at least one of:

a pre-established communication capability;

a communication between federated identity providers; and

a dynamically negotiated communication capability.

Note that the identity provider web portal 200 may itself consist of a number of identity providers. This addresses at least two needs: (1) a given user may have multiple identity providers that provide that user's identity to a multiplicity of content providers, each of which offer different variations of the same content (e.g., one is more secure, but costs more, while another is less secure and costs less), and (2) different users may use different identity providers.

At least one underlying concept that can be illustrated by FIG. 3 is the use of a federation. Microsoft has defined federation in this context as “the technology and business arrangements necessary for the interconnecting of users, applications, and systems. This includes authentication, distributed processing and storage, data sharing, and more.” Both identity providers as well as content providers can be federated as desired. This combination provides maximum flexibility for a user (e.g., the user may want to use one identity provider for secure transactions and another for non-business, insecure transactions) and especially for a group of users (since a given group of users is not beholden to using the same provider in all instances or application settings).

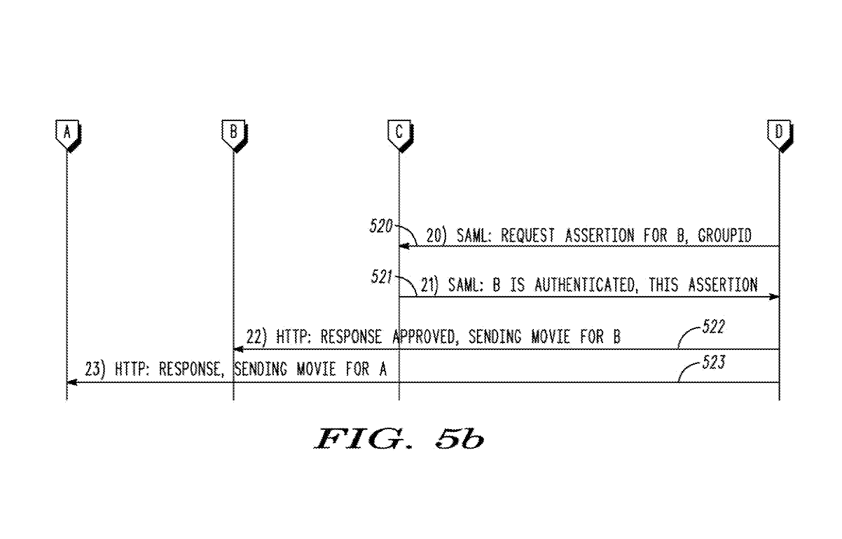

The user platforms can comprise, for example, mobile two-way communications devices of various kinds as are presently know or as are developed hereafter. With reference to FIG. 4, such a device can be configured and arranged (via, for example, appropriate programming) to effect a process 400 whereby the device provides 401 to an identity provider the aforementioned information regarding particular streaming content to be received at the mobile two-way communications device as well as regarding at least one other user to share the receiving of the selected streaming content at their own respective reception platform (i.e., a platform other than the mobile two-way communications device).

As noted above, the identity provider may be optionally capable of indicating to the mobile two-way communications device when a given selected other user has accepted or declined (or is otherwise unavailable) to share in reception of the streaming content. In such a case, if desired, this process 400 will optionally provide for receiving 402 from the identity provider information regarding participation of the at least one other user with respect to sharing such reception.

The mobile two-way communications device can then provide 403 to the identity provider information regarding initiation of providing the selected streaming content. This can comprise, if desired, an up-front instruction to begin streaming the content as soon as possible. This can also comprise, if desired, a specific instruction that itself begins the streaming process. Other possibilities may also exist in this regard.

By one approach, if desired, this process 400 may further comprise receiving 404 redirection information from the identity provider. In such a case, the mobile two-way communications device can then optionally use 405 the redirection information to receive the streaming content from the corresponding provider.

Those skilled in the art will appreciate that the above-described process is readily enabled using any of a wide variety of available and/or readily configured mobile two-way communications devices, including partially or wholly programmable platforms as are known in the art or dedicated purpose platforms as may be desired for some applications.

### EXAMPLE 1

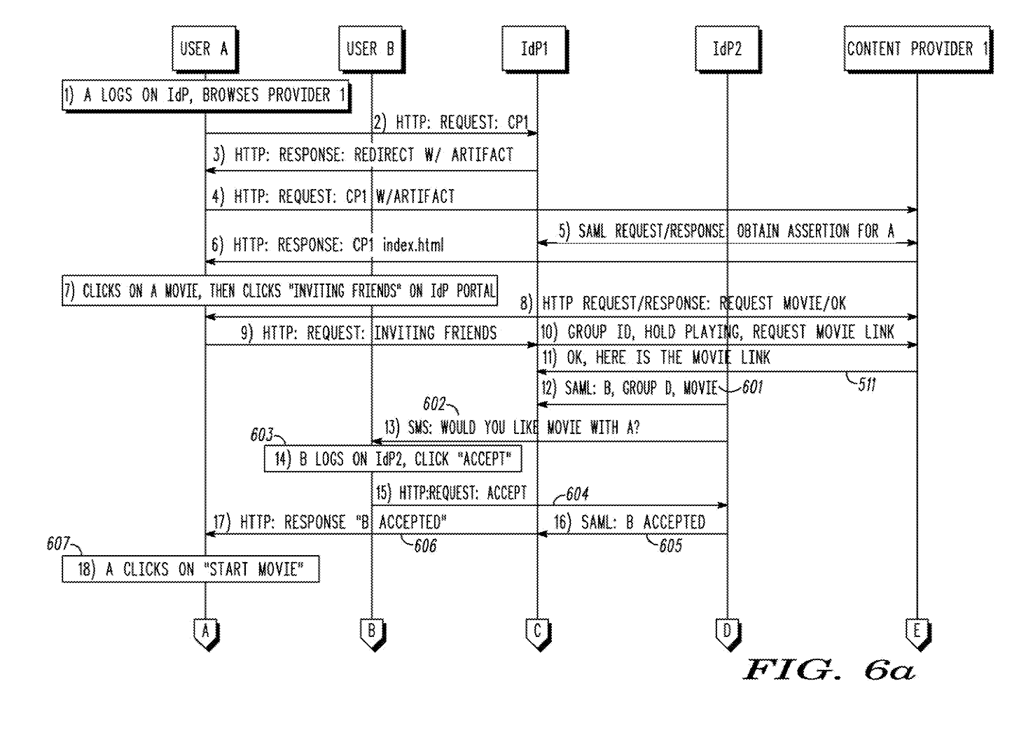

Referring now to FIG. 5, an illustrative example will now be offered. Those skilled in the art will recognize and understand that this example serves only in an illustrative capacity and is not to be taken as an exhaustive presentation of all possibilities. In particular, those skilled in the art will recognize that these teachings are in fact applicable in a wide variety of other settings.

In this example, User A logs on 501 to the identity provider (IdP) and browses provider 1's offerings and/or features. User A then transmits a hypertext transfer protocol (HTTP) message 502 to/via the identity provider web server to request content provider 1 (CP1). The identity provider responds with a message 503 that provides an enabling artifact and that serves to redirect User A to content provider 1. User A, in turn, then transmits a corresponding request 504 to content provider 1 that presents the aforementioned artifact (which may comprise, for example, a reference number of an identity and an assertion handle number).

Content provider 1 then responds by contacting the identity provider with a Security Assertion Markup Language (SAML) message 505 to request an assertion on behalf of User A, which the identity provider provides in this example. Having now fully authenticated User A, content provider 1 now transmits an index 506 of available streaming content to User A (as, in this example, a hypertext markup language (HTML) document).

User A then selects a particular item from the index and further selects an option to invite friends via the identity provider 507. This results in User A transmitting a message 508 to content provider 1 to select the content and to transmit a request 509 to the identity provider to invite the identified friends. In response to receiving the latter, the identity provider in this example transmits a message 510 to content provider 1 to provide a corresponding group identifier (ID) along with an indication to request a content link while holding the streaming (i.e., the playing or playback) of that content.

Upon receiving a message 511 from content provider 1 that contains the requested content link, the identity provider then transmits a message 512 to invite User B to share in reception of the selected content. In this example, User B logs on 513 to the identity provider and accepts the invitation. This includes transmission of a message 514 that comprises the aforementioned acceptance.

In this example, the identity provider now transmits a message 515 to User A to indicate that User B has accepted the invitation. User A now elects 516 to start the streaming process and transmits a message 517 to content provider 1 to request the content. The identity provider transmits a message 518 to User B containing a corresponding artifact and to redirect User B to content provider 1. User B, as a result, then transmits a message 519 to content provider 1 to present the artifact and to request the streaming content.

Upon receiving the latter communication, content provider 1 transmits a SAML message 520 to the identity provider to request assertion for User B. Upon receiving an authentication message 521 from the identity provider, content provider 1 transmits a response approved message 522 to User B and begins sending the selected streaming content to B. Substantially simultaneously, content provider 1 also sends a response approved message 523 to User A and also begins playback of the content for User A as well.

### EXAMPLE 2

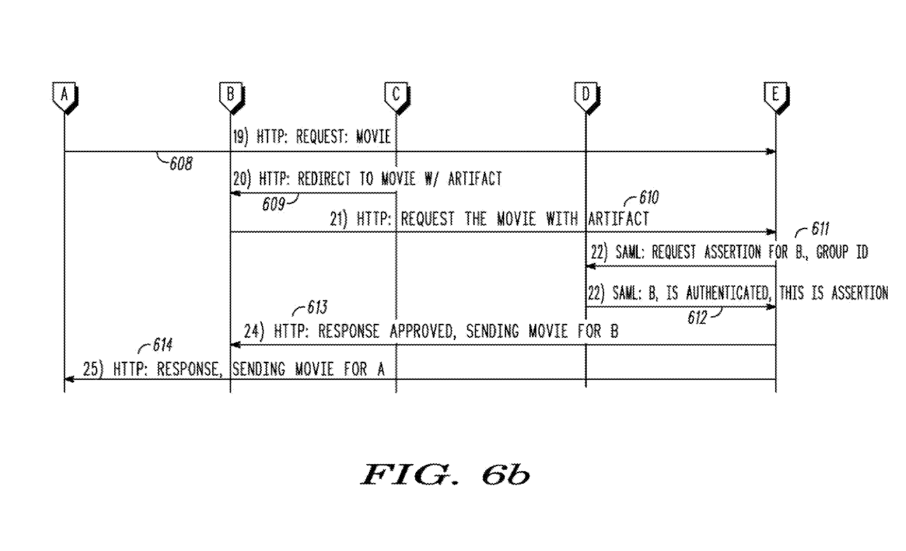

In the examples provided above, it is presumed that the users are members of a common domain that includes the identity provider. It is possible, however, that one or more of the users will be members of differing domains. Those skilled in the art will understand and appreciate, however, that these teachings are readily applied in such a context. To illustrate, and referring now to FIG. 6, in such a case the process for two users who are members of differing domains can begin as described above up through the transmission of the message 511 from content provider 1 to the originating identity provider to provide the content link.

In this illustrative example, the originating identity provider (IdP1) now transmits a SAML message 610 to the identity provider (IdP2) as corresponds to the domain for the other user (i.e., User B) to provide the Group ID and content information. This second identity provider then forwards the aforementioned invitation 602 to User B. Following acceptance 603 by User B and transmission of a corresponding message 604 to the second identity provider, the second identity provider transmits a SAML message 605 to the first identity provider to indicate such acceptance.

As before, the first identity provider now transmits an acceptance message 606 to User A and, following User A selecting a start option 607 and transmitting a corresponding content request 608 to content provider 1, the second identity provider transmits a message 609 to User B to provide a corresponding artifact and to redirect User B to content provider 1. User B then presents the artifact and content request to content provider 1 in a corresponding transmission 610 and content provider 1 conducts a SAML exchange 611 and 612 with the second identity provider to authenticate User B.

Content provider 1 then transmits appropriate message 613 and 614 to User B and User A respectively to being sending the selected streaming content to both parties at their respective reception platforms.

Again, those skilled in the art will readily recognize the significant opportunities for flexible and relatively transparent streaming content sharing these teachings represent. These approaches can be readily applied to accommodate any of a wide variety of streaming content and essentially any number of sharing users.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one simple example in this regard, when sending an invitation as described above, the message can also include, if desired, a full or partial listing of the candidate streaming content selections as were originally considered by the originating user. In such a case, and again if desired, a responding message that declines the invitation can also include a suggestion that a different one of the candidate streaming content items be consumed in a shared manner. This, in turn, can lead to presenting an invitation to the original user to join in the receiving of the newly suggested streaming content.

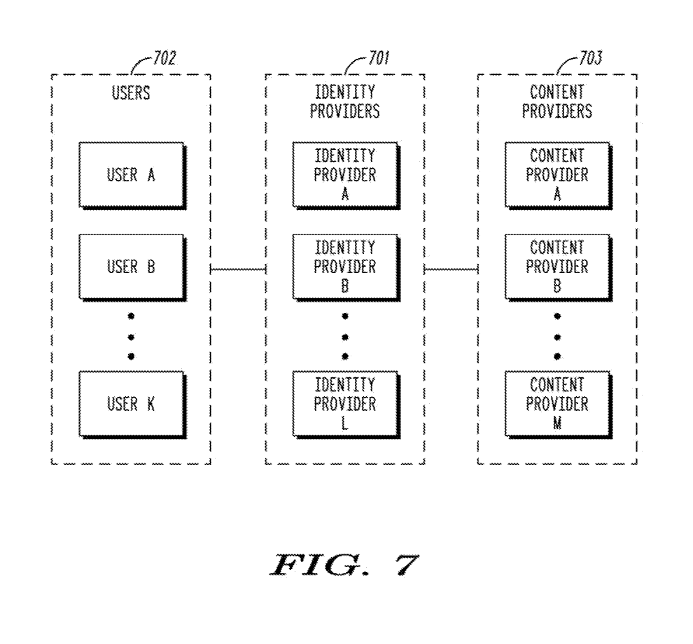

As yet another example in this regard, a plurality of federated identity providers may be available in the above examples (where, for example, the identity providers who comprise the federation already have an established level of mutual trust). In such a case, it would be possible for, say, any one of the federated identity providers to act on behalf of one or more of the users to effect the actions and functionality described. FIG. 7 illustrates such an example, wherein a set of identity providers 701 are federated with each other and with one or more users 702. Being federated, each identity provider trusts each other identity provider with which it is federated. So configured, any one of the users that use the set of federated identity providers can in turn access any content provider 703 that any of the federated identity providers can access.

We claim:

1. A method comprising:
at an identity provider:
communicating with a first logged-in user who seeks to receive particular streaming content at a corresponding first user platform and who has identified at least one other user with whom the first logged-in user wishes to share the receiving of the particular streaming content;
inviting the at least one other user to share the receiving of the particular streaming content;
receiving an acceptance of the invitation from the at least one other user when the at least one other user is logged-in with the identity provider from a corresponding second user platform to thereby provide a logged-in participating second user;
automatically directing the first logged-in user and the logged-in participating second user to a content provider to facilitate substantially simultaneous receipt of the particular streaming content at the first and second user platform.

2. The method of claim 1 wherein communicating with a first logged-in user who seeks to receive particular streaming content at a corresponding first user platform and who identifies at least one other user with whom the first logged-in user wishes to share the receiving of the particular streaming content comprises, at least in part:
providing the first logged-in user with a plurality of candidate streaming content options;
receiving from the first logged-in user a selection of a particular one of the plurality of candidate streaming content options to thereby identify the particular streaming content to be received at the corresponding first user platform, wherein the plurality of candidate streaming content options are available to be sourced by at least one content servers;
transmitting the selection of the particular one of the plurality of content streaming options to the at least one other user;
matching the particular streaming content option to a set of streaming content options that are available to the at least one other user;
coordinating with the at least one other user a use of selected content provider options.

3. The method of claim 1 wherein the particular streaming content comprises at least one of:
audio-only streaming content;
video-only streaming content;
audio-visual streaming content;
interactive streaming content.

4. The method of claim 1 wherein inviting the at least one other user to share the receiving of the particular streaming content comprises, at least when the at least one other user is not already logged-in with the identity provider, transmitting a message to the at least one other user.

5. The method of claim 4 wherein the message comprises at least one of:
a short message service (SMS) message;
a multimedia message service (MMS) message;
an email message;
a voice message;
a page message;
an instant messaging (IM) message.

6. The method of claim 1 wherein receiving an acceptance of the invitation from the at least one other user when the at least one other user is logged-in with the identity provider from a corresponding second user platform comprises receiving the acceptance via a web portal for the identity provider.

7. The method of claim 6 wherein the web portal is configured and arranged to be used by multiple identity providers that are, in turn, configured and arranged to be used as either of an individual identity provider and as a federated identity provider.

8. The method of claim 1 wherein automatically directing the first logged-in user and the logged-in participating second user to a content provider to facilitate substantially simultaneous receipt of the particular streaming content at the first and second user platform comprises, at least in part, the identity provider providing some required assertions for user authentication to the content provider on behalf of the first logged-in user and the logged-in participating second user.

9. The method of claim 1 wherein the first logged-in user and the at least one other user are members of different domains and wherein receiving an acceptance of the invitation from the at least one other user when the at least one other user is logged-in with the identity provider from a corresponding second user platform to thereby provide a logged-in participating second user further comprises, at least in part, the identity provider communicating with an identity provider for a domain as corresponds to the at least one other user, the communication between identity providers being at least one of:
a pre-established communication capability;
a communication between federated identity providers; and
a dynamically negotiated communication capability.

10. An identity provider comprising:
a communications interface;
a processor operably coupled to the communications interface and being configured and arranged to:
communicate with a first logged-in user who seeks to receive particular streaming content at a corresponding first user platform and who has identified at least one other user with whom the first logged-in user wishes to share the receiving of the particular streaming content;
invite the at least one other user to share the receiving of the particular streaming content;
receive an acceptance of the invitation from the at least one other user when the at least one other user is logged-in with the identity provider from a corresponding second user platform to thereby provide a logged-in participating second user;
automatically direct the first logged-in user and the logged-in participating second user to a content provider to facilitate substantially simultaneous receipt of the particular streaming content at the first and second user platform.

11. The identity provider of claim 10 wherein the processor is further configured and arranged to communicate with a first logged-in user who seeks to receive particular streaming content at a corresponding first user platform and who has identified at least one other user with whom the first logged-in user wishes to share the receiving of the particular streaming content by, at least in part:
providing the first logged-in user with a plurality of candidate streaming content options;
receiving from the first logged-in user a selection of a particular one of the plurality of candidate streaming content options to thereby identify the particular streaming content to be received at the corresponding first user platform.

12. The identity provider of claim 10 wherein the particular streaming content comprises at least one of:
audio-only streaming content;
video-only streaming content;
audio-visual streaming content;
interactive streaming content.

13. The identity provider of claim 10 wherein the processor is further configured and arranged to invite the at least one other user to share the receiving of the particular streaming content by, at least when the at least one other user is not already logged-in with the identity provider, transmitting a message to the at least one other user.

14. The identity provider of claim 13 wherein the message comprises at least one of:
a short message service (SMS) message;
a multimedia message service (MMS) message;
a voice message;
a page message;
an email message;
an instant messaging (IM) message.

15. The identity provider of claim 10 wherein the processor is further configured and arranged to receive an acceptance of the invitation from the at least one other user when the at least one other user is logged-in with the identity provider from a corresponding second user platform by receiving the acceptance via a web portal for the identity provider.

16. The identity provider of claim 10 wherein the processor is further configured and arranged to automatically direct the first logged-in user and the logged-in participating second user to a content provider to facilitate substantially simultaneous receipt of the particular streaming content at the first and second user platform by, at least in part, providing at least some required assertions for user authentication to the content provider on behalf of the first logged-in user and the logged-in participating second user.

17. The identity provider of claim 10 wherein the first logged-in user and the at least one other user are members of different domains and wherein the processor is further configured and arranged to receive an acceptance of the invitation from the at least one other user when the at least one other user is logged-in with the identity provider from a corresponding second user platform to thereby provide a logged-in participating second user further by, at least in part, the identity provider communicating with an identity provider for a domain as corresponds to the at least one other user.

18. A method comprising:
at a mobile two-way communications device:
providing to an identity provider information regarding particular streaming content to be received at the mobile two-way communications device and regarding at least one other user to share the receiving of the particular streaming content at their own respective reception platform;
providing to the identity provider information regarding initiation of providing the particular streaming content.

19. The method of claim 18 further comprising:
receiving from the identity provider information regarding participation of the at least one other user with respect to sharing reception of the particular streaming content.

20. The method of claim 18 further comprising:
receiving from the identity provider redirection information;
using the redirection information to receive the particular streaming content from a corresponding provider.
